(19) United States
(12) Patent Application Publication
(10) Pub. No.: US 2007/0177605 A1
(43) Pub. Date: Aug. 2, 2007

(54) Method for utilizing a backup timing source when GPS becomes nonfunctional

(76) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/342,507

(22) Filed: Jan. 30, 2006

(51) Int. Cl. H04L 12/56; H04J 1/16

(52) U.S. Cl. 370/395.4; 370/216

(57) ABSTRACT

The present invention provides a method for utilizing a backup timing source in digital communication systems when GPS becomes nonfunctional. When a base station fails to receive an expected signal from a GPS satellite, a GPS failure timer is started. If the base station does not receive a signal from the GPS satellite prior to the expiration of the timer, the wireless communication system switches to a backup timing system, such as NTP (Network Time Protocol).

### FIELD OF THE INVENTION

The present invention relates generally to communication systems, and more particularly to time synchronization in digital wireless communication systems.

### BACKGROUND OF THE INVENTION

Wireless communication systems have become ubiquitous. Wireless communications infrastructure is dependent upon precise timing for proper operation. For example, Code Division Multiple Access (CDMA) systems require synchronous timing for proper operation. Without synchronous timing, base stations are not able to successfully hand off calls.

In CDMA communication systems, the oscillators in base stations calibrate themselves against GPS (Global Positioning System) satellites. In the event that the base stations stop receiving signals from the GPS satellites, the base station oscillators revert to what is known as “free running” mode. Since each base station is now running its own timing operation, over time the relative timing between base stations drift apart. Once the time synchronization between base stations has drifted beyond an accepted level, the base stations are no longer able to successfully hand off calls. In this mode, mobile units are only able to place or receive calls if they remain stationary within the communication area of a single base station.

However, the reliance of communication systems on GPS satellites for timing synchronization brings on several problems. First, GPS is owned and operated by the U.S. Department of Defense, and therefore not under direct or indirect control of wireless service providers or non-U.S. governments. Further, GPS represents a single point of failure in the overall CDMA architecture. Additionally, GPS satellites and ground installations used to propagate GPS timing are attractive targets for terrorist attacks, since GPS is essential to military operations and supports many commercial applications.

Therefore, a need exists for a method for allowing reliable communications in a wireless communication system when GPS is not operational.

### BRIEF SUMMARY OF THE INVENTION

An exemplary embodiment of the present invention provides a method for utilizing a backup timing source when GPS becomes nonfunctional. A communication system determines if GPS timing is functional. If GPS timing is not functional, a Mobile Switching Center (MSC) starts a GPS failure timer, which is preferably set to a time that is greater than any predictable short-term interruptions in communications between a GPS satellite and base stations that are under the control of the MSC.

The MSC determines if the GPS failure timer has expired. In the interim between GPS timing becoming nonfunctional and the start of backup timing, each base station runs in free-running mode. In this mode, each base station includes an oscillator that is used to maintain timing accuracy.

When the GPS failure timer has expired, the MSC converts to NTP server timing. In NTP server timing mode, the base stations preferably utilize NTP and stratum 1 NTP servers as a backup timing source. In this exemplary embodiment, each base station includes a link to an NTP server. In a further exemplary embodiment, the base stations utilize NTP and stratum 2 NTP servers as a backup timing source. In this manner, a backup timing source is provided that provides a synchronous backup timing for the communication system. This allows communication systems to continue to operate with full functionality, including maintaining that functionality of soft handoff and other timing-dependent services.

The present invention also provides a method for switching back to a GPS timing mode when GPS timing returns to functionality. The communication system runs in NTP Serving Timing Mode, where synchronous timing between digital cellular base stations is maintained over a link utilizing an NTP server.

At some point, the communication system determines if the GPS system has become functional, such as when the base stations receive valid timing signals from GPS satellites over a predetermined period of time.

If the GPS system has returned to functionality, the communication system switches to GPS timing mode. The present invention thereby provides the ability of a digital communication system that utilizes GPS for synchronous timing to continue to maintain full-features operation, even when the GPS system is rendered inoperable.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flowchart of a method for utilizing a backup timing source when GPS becomes nonfunctional in accordance with an exemplary embodiment of the present invention.

FIG. 3 depicts a flowchart of a method for switching back to a GPS timing mode in accordance with an exemplary embodiment of the present invention.

### DETAILED DESCRIPTION OF THE INVENTION

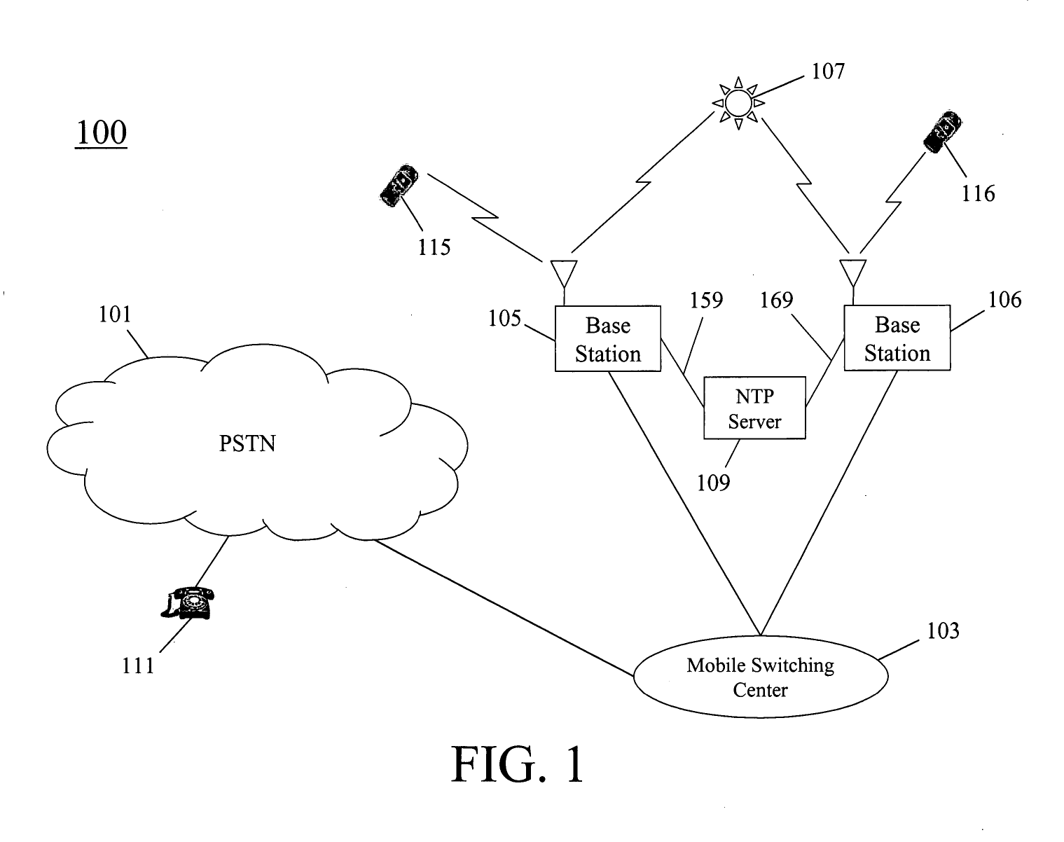

FIG. 1 depicts a communication system 100 in accordance with an exemplary embodiment of the present invention. Communication system 100 includes Public Switched Telephone Network (PSTN) 101, Mobile Switching Center (MSC) 103, base station 105, base station 106, Global Positioning System (GPS) satellite 107, and NTP (Network Time Protocol) server 109.

PSTN 101 is an international telephone network that provides telephony service to users connected to PSTN 101. Customer Premises Equipment (CPE) 111 is coupled to communication system 100 via PSTN 101 and provides the ability for users to place and receive calls within communication system 100.

MSC 103 connects PSTN 101 to the wireless communication system services by MSC 103. MSC 103 is preferably responsible for compiling call information for billing and handing off calls from one cell to another. In an exemplary embodiment, MSC 103 is a CDMA MSC. MSC 103 provides control for base stations 105 and 106. It should be understood that in a typical wireless communication system, MSC 103 would control a plurality of base stations, although FIG. 1 depicts only two base stations for clarity.

Base stations 105 and 106 are responsible for communicating over the air with mobile units that are located within a cell area covered by the base station. Base stations 105 and 106 complete calls with PSTN 101 utilizing MSC 103. In the exemplary embodiment depicted in FIG. 1, base station 105 is communicating over the air with mobile unit 115, and base station 106 is communicating over the air with mobile unit 116. It should be understood that, although FIG. 1 only depicts two mobile units 115 and 116, it should be understood that a typical wireless base station services a plurality of wireless units at one time. In an exemplary embodiment, base stations 105 and 106 are CDMA base stations and mobile units 115 and 116 are CDMA mobile units.

GPS satellite 107 is part of a satellite-based radio navigation system run by the U.S. Department of Defense. The GPS system includes a plurality of satellites, only one of which, GPS satellite 107, is depicted in FIG. 1. In the GPS system, signals from at least four satellites are available anywhere on earth. The signals from the GPS satellites are sufficient to compute the current location, both latitude and longitude, and elevation. GPS location determinations are accurate to within 20 meters. Each GPS satellite orbits approximately 12,500 miles above the earth and circles the earth every twelve hours. Each satellite constantly transmits location and the time of day. The time of day comes from atomic clocks.

NTP server 109 is a server that utilizes the NTP protocol, which is a protocol designed to synchronize the clocks of computers over a network. NTP servers are categorized by stratum level. For example, stratum 1 NTP servers maintain system time synchronization with the US Naval Observatory Master Clocks in Washington, DC and Colorado Springs, Colo. There are approximately 100 Stratum 1 servers worldwide. Stratum 2 NTP servers are preferably fed from stratum 1 servers, and there are more than 100 stratum 2 servers worldwide.

Base station 105 is coupled to NTP server 109 via link 159, and base station 106 is coupled to NTP server 109 via link 169. In an exemplary embodiment, links 159 and 169 are wired Internet Protocol (IP) links.

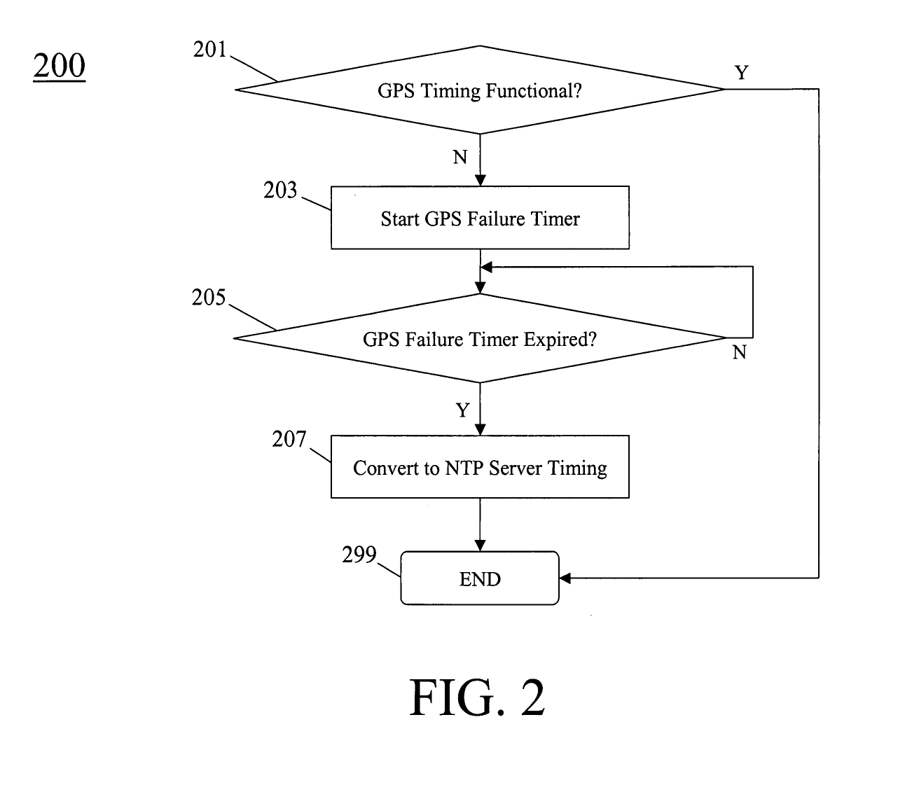

FIG. 2 depicts a flowchart 200 of a method for utilizing a backup timing source when GPS becomes nonfunctional in accordance with an exemplary embodiment of the present invention.

Communication system 100 determines (201) if GPS timing is functional. GPS can become nonfunctional if it is taken out of service, from a technical problem, atmospheric issues, sabotage or terrorism, or other reasons. In an exemplary embodiment, base stations 105 and 106 cease receiving a signal from GPS satellite 107 and notify MSC 103 that they have not received the signal from GPS satellite 107.

If GPS timing is not functional as determined at step 201, MSC 103 starts (203) a GPS failure timer. The GPS failure timer is preferably set to a time that is greater than any predictable short-term interruptions in communications between GPS satellite 107 and base stations 105 and 106. In an exemplary embodiment, the GPS failure timer is set to one hour.

MSC 103 determines (205) if the GPS failure timer has expired. If not, MSC 103 continues operation and returns to recheck the status of the GPS failure timer. In an exemplary embodiment, base stations 105 and 106 run in free-running mode in the period between non-functionality of GPS satellite 107 and the utilization of a backup timing system. In the free-running mode, each base station includes an oscillator that is used to maintain timing accuracy.

If MSC 103 determines at step 205 that the GPS failure timer has expired, MSC 103 converts (207) to NTP server timing. In NTP server timing mode, base stations 105 and 106 preferably utilize NTP and stratum 1 NTP servers as a backup timing source. In this exemplary embodiment, each base station includes a link to an NTP server. In a further exemplary embodiment, base stations 105 and 106 utilize NTP and stratum 2 NTP servers as a backup timing source. In this manner, a backup timing source is provided that provides a synchronous backup timing for communication system 100. This allows communication system 100 to continue to operate with full functionality, including maintaining that functionality of soft handoff and other timing-dependent services.

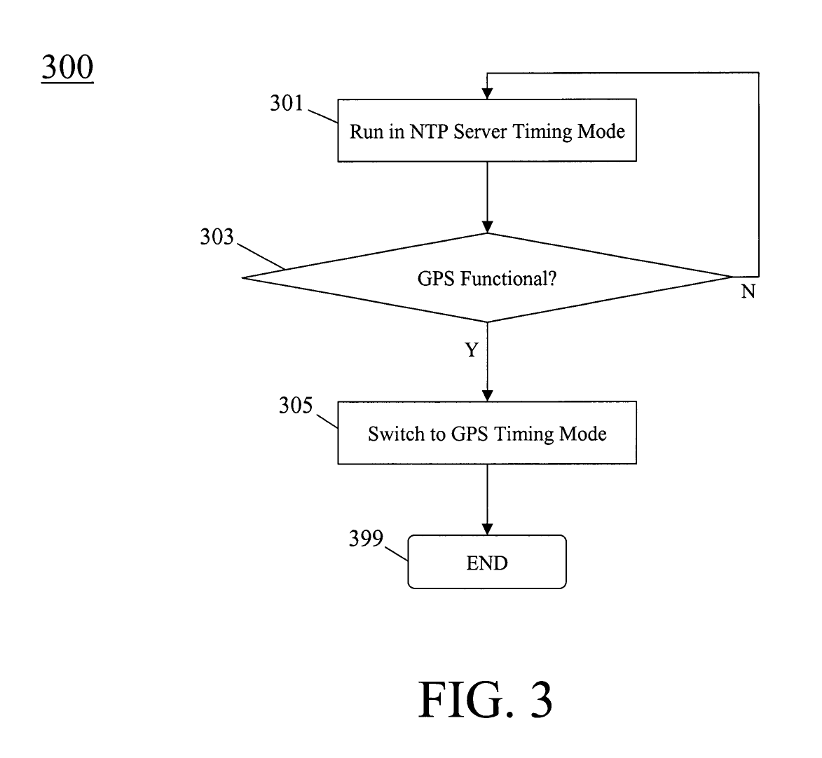

FIG. 3 depicts a flowchart 300 of a method for switching back to a GPS timing mode in accordance with an exemplary embodiment of the present invention.

Communication system 100 runs (301) in NTP Serving Timing Mode. This mode is entered, for example, by the processing depicted in FIG. 2. In this timing mode, synchronous timing between digital cellular base stations is maintained over a link utilizing an NTP server.

Communication system 100 determines (303) if the GPS system has become functional. In an exemplary embodiment, communication system 100 determines that the GPS system has returned to functionality when base stations receive valid timing signals from GPS satellites over a predetermined period of time. The predetermined period of time is such that it assures that GPS system is back in service and not sending out sporadic signals whole not being fully functional. If the GPS system is not functional, the process continues to run (301) in NTP server timing mode.

If the GPS system has returned to functionality as determined at step 303, communication system 100 switches (305) to GPS timing mode. The present invention thereby provides the ability of a digital communication system that utilizes GPS for synchronous timing to continue to maintain full-features operation, even when the GPS system is rendered inoperable.

While this invention has been described in terms of certain examples thereof, it is not intended that it be limited to the above description, but rather only to the extent set forth in the claims that follow.

We claim:

1. A method for utilizing a backup timing source in a wireless communication system that utilizes GPS (Global Positioning System) as a primary timing source, the method comprising:
determining that the primary timing source has become nonfunctional; and
switching to a backup timing source.

2. A method for utilizing a backup timing source in accordance with claim 1, wherein the step of determining that the primary timing source has become nonfunctional comprises failing to receive an expected signal from the primary timing source.

3. A method for utilizing a backup timing source in accordance with claim 2, wherein the step of failing to receive an expected signal from the primary timing source comprises failing to receive a signal from a GPS satellite.

4. A method for utilizing a backup timing source in accordance with claim 2, wherein the step of failing to receive an expected signal from the primary timing source comprises failing to receive a signal from the primary timing source for a predetermined period of time.

5. A method for utilizing a backup timing source in accordance with claim 1, wherein the step of determining that the primary timing source has become nonfunctional comprises:
starting a timer upon failing to receive a first expected timing signal from the first timing source; and
determining that the primary timing source has become nonfunctional upon expiration of the timer.

6. A method for utilizing a backup timing source in a digital communication system that utilizes GPS (Global Positioning System) as a primary timing source, the method comprising:
determining that GPS has become nonfunctional;
starting a failure timer; and
upon expiration of the timer, switching to a backup timing source.

7. A method for utilizing a backup timing source in accordance with claim 6, wherein the step of determining that GPS has become nonfunctional comprises failing to receive an expected signal from a GPS satellite.

8. A method for utilizing a backup timing source in accordance with claim 6, the method further comprising the step of returning to the primary timing source.

9. A method for utilizing a backup timing source in accordance with claim 8, wherein the step of returning to the primary timing source comprises determining that GPS has become functional.

10. A method for utilizing a backup timing source in accordance with claim 9, wherein the step of returning to the primary timing source comprises determining that GPS has become functional for a predetermined period of time.

11. A method for utilizing a backup timing source in accordance with claim 6, wherein the step of switching to a backup timing source comprises utilizing an NTP (Network Time Protocol) link.

12. A method for switching from a backup timing source to a primary timing source, the method comprising:
running in a backup timing mode;
determining when the primary timing source returns to service; and
switching to the primary timing source.

13. A method for switching from a backup timing source to a primary timing source in accordance with claim 12, wherein the step of running in a backup timing mode comprises utilizing a land-based server to provide synchronous timing.

14. A method for switching from a backup timing source to a primary timing source in accordance with claim 13, wherein the land-based server is an NTP (Network Time Protocol) server.

15. A method for switching from a backup timing source to a primary timing source in accordance with claim 12, wherein the step of determining when the primary timing source returns to service comprises receiving valid timing signals from the primary timing source.

16. A method for switching from a backup timing source to a primary timing source in accordance with claim 15, wherein the primary timing source is a GPS satellite.

17. A method for switching from a backup timing source to a primary timing source in accordance with claim 12, wherein the step of determining when the primary timing source returns to service comprises receiving signals from the primary timing source for a predetermined period of time.
